(19) United States
(12) Patent Application Publication
(10) Pub. No.: US 2024/0193422 A1
(43) Pub. Date: Jun. 13, 2024

(54) NEURON-BY-NEURON QUANTIZATION FOR EFFICIENT TRAINING OF LOW-BIT QUANTIZED NEURAL NETWORKS

(71) Applicant: Smart Engines Service, LLC, Moscow (RU)

(72) Inventors: Artem Vladimirovich SHER, Moscow (RU); Anton Vsevolodovich TRUSOV, Moscow (RU); Elena Evgenyevna LIMONOVA, Moscow (RU); Dmitry Petrovich NIKOLAEV, Moscow (RU); Vladimir Viktorovich ARLAZAROV, Moscow (RU)

(21) Appl. No.: 18/104,043

(22) Filed: Jan. 31, 2023

(30) Foreign Application Priority Data
Dec. 8, 2022 (RU) 2022132132

(51) Int. Cl. G06N 3/084; G06N 3/0495

(52) U.S. Cl. CPC G06N 3/084; G06N 3/0495

(57) ABSTRACT

Quantization of a convolutional neural network (CNN) into a quantized neural network (QNN) reduces the computational resources required to operate the neural network, which is especially advantageous for operation of a neural network on resource-constrained devices. However, QNNs with low bit-widths suffer from significant losses in accuracies. Accordingly, approaches for quantization-aware training are disclosed that utilize component-by-component quantization during training to improve the accuracy of the resulting QNN. Component-by-component quantization may include filter-by-filter quantization, or preferably neuron-by-neuron quantization with some form of gradient forwarding.

### CROSS-REFERENCE TO RELATED APPLICATIONS

This application claims priority to Russian Patent App. No. 2022132132, filed on Dec. 8, 2022, which is hereby incorporated herein by reference as if set forth in full.

### BACKGROUND

### Field of the Invention

The embodiments described herein are generally directed to quantized neural networks, and, more particularly, to the training of low-bit quantized neural networks using component-by-component (e.g., neuron-by-neuron or filter-by-filter) quantization.

### Description of the Related Art

Convolutional neural networks (CNNs) are widely used in modern computer vision problems, such as pattern recognition (Ref14), semantic segmentation (Ref16), and others (Ref1, Ref21, Ref5). To achieve results with high accuracy, modern CNNs require billions of floating-point parameters. This consumes a lot of memory (e.g., 500 Megabytes for the Visual Geometry Group (VGG)-16 architecture, as described in Ref23) and requires a large amount of computational resources. However, many devices, such as system-on-a-chip (SoC) devices, Internet-of-things (IOT) devices, and other devices that utilize application-specific integrated circuits (ASICs), field-programmable gate arrays (FPGAs), and/or low-power central processing units (CPUs), are not efficient enough to operate large CNNs (Ref17).

Quantized neural networks (QNNs) have been developed to resolve the issue of resource-constrained devices not having sufficient resources for modern CNNs (Ref8, Ref10). A QNN is a neural network in which at least some of the floating-point values are replaced with fixed-point (integer) values. This transformation is called “quantization.” The weights and/or activations of a neural network can be quantized.

The state-of-the-art standard, implemented in popular machine-learning libraries, such as Pytorch (Ref19) and Keras (Ref6), is 8-bit quantization. 8-bit QNNs are efficient for CPUs, as they operate several times faster than full-precision CNNs, while having almost the same accuracy as full-precision CNNs. However, 8-bit QNNs can still be too resource-demanding for FPGAs and other low-power devices.

Thus, 4-bit quantization or even lower quantizations have become of great interest. Unfortunately, even though it is possible to train low-bit QNNs, such as binary-bit (i.e., 2-bit), ternary-bit (i.e., 3-bit), and others (Ref20, Ref2), such QNNs suffer from a significant loss in accuracy, relative to full-precision CNNs (Ref8).

There are two different approaches to QNN training: (i) Quantization-Aware Training (QAT); and (ii) Post-Training Quantization (PTQ) (Ref18). Both approaches include pre-training of a full-precision model. QAT includes additional training of the neural network during a quantization process. PTQ quantizes the weights of the model and calibrates the parameters of the activations. QAT has a higher computational cost than PTQ, but produces a QNN with higher accuracy than PTQ.

A problem with the QAT approach is that the quantization operation is non-differentiable. This means that back-propagation of the gradients through the QNN is impossible. However, this problem can be solved with the use of a Straight-Through Estimator (STE) (Ref4), which approximates quantization using a differentiable function.

The simplest way to apply QAT is the “direct” method, which takes the pre-trained full-precision model and all training data, quantizes the neural network, and then retrains the neural network to increase its accuracy using an STE. However, at low bit-width, the neural network loses too much information after quantization and cannot recover this lost information during retraining (Ref9).

Another way to apply QAT is the “layer-by-layer” method, which greedily quantizes and retrains the model. The parameters of the first layer are quantized and their values are preserved during the rest of the training (i.e., the layer is “frozen”), and then all the remaining layers are retrained. This procedure is repeated for each layer of the neural network sequentially. The layer-by-layer method does not require an STE, and therefore, is more mathematically correct. However, it is greedy, such that the resulting QNN may be suboptimal.

### SUMMARY

Accordingly, systems, methods, and non-transitory computer-readable media are disclosed for a new QAT approach.

In an embodiment, a method of training a neural network comprises using at least one hardware processor to: for each layer to be quantized in the neural network, for each of a plurality of iterations, until all of a plurality of components of the layer are quantized, select a subset of the plurality of components, wherein each of the plurality of components comprises weights, quantize the weights in the subset of components, retrain the neural network, and freeze the subset of components, such that the subset of components is not subsequently modified during training.

Each of the plurality of components may be a neuron that comprises one or more filters and an activation that produces an input to a subsequent layer from an output of the one or more filters. The method may further comprise using the at least one hardware processor to, for each of the plurality of iterations, quantize a corresponding portion of the input to the subsequent layer. Freezing the subset of components may comprise freezing weights of the one or more filters.

The method may further comprise using the at least one hardware processor to: construct a histogram of a data distribution of inputs to the subsequent layer; and solve a minimum mean-square error problem to obtain one or more parameters of quantization based on the constructed histogram, wherein the one or more parameters are used to quantize the input to the subsequent layer. The one or more parameters may comprise a scale S having a real value and an offset O having an integer value, and quantizing the input may comprise performing a quantization operation on each real-valued element r in an input array as follows:

$$q ( r ) = [ \frac{r}{S} + O ]$$

wherein q(r) is a quantized value for the real-valued element r.

Each subset of components may consist of a single neuron.

Retraining the network may comprise back-propagating gradients to all quantized layers. Retraining the network may comprise back-propagating a gradient from the layer to another layer that immediately precedes the layer in forward order of the neural network.

Each of the plurality of components may be a filter. A number of the plurality of iterations may be predefined as N, and selecting the subset of components may comprise selecting 1/N filters within the layer, such that all filters in the layer are selected over the plurality of iterations. In an embodiment, N≥4. The subset of components may consist of one or more filters, and freezing the subset of components may comprise freezing weights of the one or more filters in the subset of components.

The method may further comprise using the at least one hardware processor to, for each of the plurality of iterations, prior to retraining the neural network, quantize an input to the one or more filters in the subset of components.

The method may further comprise using the at least one hardware processor to: construct a histogram of a data distribution of inputs to the subset of components; and solve a minimum mean-square error problem to obtain one or more parameters of quantization based on the constructed histogram, wherein the one or more parameters are used to quantize the input. The one or more parameters may comprise a scale S having a real value and an offset O having an integer value, and quantizing the input may comprise performing a quantization operation on each real-valued element r in an input array as follows:

$$q ( r ) = [ \frac{r}{S} + O ]$$

wherein q(r) is a quantized value for the real-valued element r.

Quantizing the weights may comprise solving:

S,O:argmin( [symbol] (r−q_{S,O}(r))²)

wherein S is a scale having a real value, O is an offset having an integer value, and [symbol] (r−q_{S,O}(r))² is a mean-square error function that calculates an error between real values r of the weights and quantized values q_{S,O}(r), wherein

$${q}_{S , O} ( r ) = [ \frac{r}{S} + O ] .$$

The solving may comprise a ternary search.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example processing system, by which one or more of the processes described herein, may be executed, according to an embodiment;

FIG. 2 illustrates a standard convolutional layer in a full-precision CNN, according to an example;

FIG. 3 illustrates a quantization module that can be used in place of each convolutional layer of a full-precision CNN during training of a QNN, according to an embodiment;

FIG. 4 illustrates the accuracy of direct training, according to an example;

FIG. 5 illustrates a process for layer-by-layer training, according to an embodiment;

FIG. 6 illustrates the accuracy of layer-by-layer training, according to an embodiment;

FIG. 7 illustrates a process for filter-by-filter training, according to an embodiment;

FIGS. 8 and 9 illustrate the accuracy of filter-by-filter training, according to alternative embodiments;

FIG. 10 illustrates a process for neuron-by-neuron training, according to an embodiment; and

FIGS. 11-13 illustrate the accuracy of neuron-by-neuron training, according to alternative embodiments.

### DETAILED DESCRIPTION

In an embodiment, systems, methods, and non-transitory computer-readable media are disclosed for a new QAT approach. In particular, three new QAT approaches are disclosed: (i) filter-by-filter quantization with different groupings, representing a modification of the layer-by-layer method in which only a subset of filters in a layer freezes on each iteration, rather than the whole layer; (ii) neuron-by-neuron quantization, representing a modification of filter-by-filter quantization, in which neurons (i.e., weights and activations) freeze simultaneously; and (iii) neuron-by-neuron quantization with STE gradient propagation to the quantized portion of the neural network.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. SYSTEM OVERVIEW

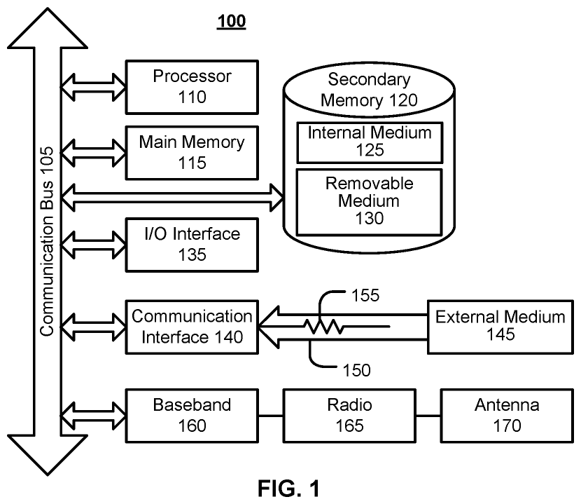

FIG. 1 is a block diagram illustrating an example wired or wireless system 100 that may be used in connection with various embodiments described herein. For example, system 100 may be used as or in conjunction with one or more of the functions, processes, or methods (e.g., to store and/or execute one or more software modules) described herein. System 100 can be a server or any conventional personal computer, or any other processor-enabled device that is capable of wired or wireless data communication. Other computer systems and/or architectures may be also used, as will be clear to those skilled in the art.

System 100 preferably includes one or more processors 110. Processor(s) 110 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 110. Examples of processors which may be used with system 100 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 110 is preferably connected to a communication bus 105. Communication bus 105 may include a data channel for facilitating information transfer between storage and other peripheral components of system 100. Furthermore, communication bus 105 may provide a set of signals used for communication with processor 110, including a data bus, address bus, and/or control bus (not shown). Communication bus 105 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 100 preferably includes a main memory 115 and may also include a secondary memory 120. Main memory 115 provides storage of instructions and data for programs executing on processor 110, such as one or more of the functions and/or modules discussed herein. It should be understood that programs stored in the memory and executed by processor 110 may be written and/or compiled according to any suitable language, including without limitation C/C++, Java, JavaScript, Perl, Visual Basic, .NET, and the like. Main memory 115 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 120 is a non-transitory computer-readable medium having computer-executable code (e.g., any of the software disclosed herein) and/or other data stored thereon. The computer software or data stored on secondary memory 120 is read into main memory 115 for execution by processor 110. Secondary memory 120 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 120 may optionally include an internal medium 125 and/or a removable medium 130. Removable medium 130 is read from and/or written to in any well-known manner. Removable storage medium 130 may be, for example, a magnetic tape drive, a compact disc (CD) drive, a digital versatile disc (DVD) drive, other optical drive, a flash memory drive, and/or the like.

In alternative embodiments, secondary memory 120 may include other similar means for allowing computer programs or other data or instructions to be loaded into system 100. Such means may include, for example, a communication interface 140, which allows software and data to be transferred from external storage medium 145 to system 100. Examples of external storage medium 145 include an external hard disk drive, an external optical drive, an external magneto-optical drive, and/or the like.

As mentioned above, system 100 may include a communication interface 140. Communication interface 140 allows software and data to be transferred between system 100 and external devices (e.g. printers), networks, or other information sources. For example, computer software or data may be transferred to system 100, over one or more networks (e.g., including the Internet), from a network server via communication interface 140. Examples of communication interface 140 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 100 with a network or another computing device. Communication interface 140 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 140 are generally in the form of electrical communication signals 155. These signals 155 may be provided to communication interface 140 via a communication channel 150. In an embodiment, communication channel 150 may be a wired or wireless network, or any variety of other communication links. Communication channel 150 carries signals 155 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 115 and/or secondary memory 120. Computer-executable code can also be received via communication interface 140 and stored in main memory 115 and/or secondary memory 120. Such computer-executable code, when executed, enable system 100 to perform the various functions of the disclosed embodiments as described elsewhere herein.

In this description, the term “computer-readable medium” is used to refer to any non-transitory computer-readable storage media used to provide computer-executable code and/or other data to or within system 100. Examples of such media include main memory 115, secondary memory 120 (including internal memory 125 and/or removable medium 130), external storage medium 145, and any peripheral device communicatively coupled with communication interface 140 (including a network information server or other network device). These non-transitory computer-readable media are means for providing software and/or other data to system 100.

In an embodiment that is implemented using software, the software may be stored on a computer-readable medium and loaded into system 100 by way of removable medium 130, I/O interface 135, or communication interface 140. In such an embodiment, the software is loaded into system 100 in the form of electrical communication signals 155. The software, when executed by processor 110, preferably causes processor 110 to perform one or more of the processes and functions described elsewhere herein.

In an embodiment, I/O interface 135 provides an interface between one or more components of system 100 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 100 may also include optional wireless communication components that facilitate wireless communication over a voice network and/or a data network (e.g., in the case of a mobile device, such as a smart phone). The wireless communication components comprise an antenna system 170, a radio system 165, and a baseband system 160. In system 100, radio frequency (RF) signals are transmitted and received over the air by antenna system 170 under the management of radio system 165.

In an embodiment, antenna system 170 may comprise one or more antennae and one or more multiplexors (not shown) that perform a switching function to provide antenna system 170 with transmit and receive signal paths. In the receive path, received RF signals can be coupled from a multiplexor to a low noise amplifier (not shown) that amplifies the received RF signal and sends the amplified signal to radio system 165.

In an alternative embodiment, radio system 165 may comprise one or more radios that are configured to communicate over various frequencies. In an embodiment, radio system 165 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 165 to baseband system 160.

If the received signal contains audio information, then baseband system 160 decodes the signal and converts it to an analog signal. Then the signal is amplified and sent to a speaker. Baseband system 160 also receives analog audio signals from a microphone. These analog audio signals are converted to digital signals and encoded by baseband system 160. Baseband system 160 also encodes the digital signals for transmission and generates a baseband transmit audio signal that is routed to the modulator portion of radio system 165. The modulator mixes the baseband transmit audio signal with an RF carrier signal, generating an RF transmit signal that is routed to antenna system 170 and may pass through a power amplifier (not shown). The power amplifier amplifies the RF transmit signal and routes it to antenna system 170, where the signal is switched to the antenna port for transmission.

Baseband system 160 is also communicatively coupled with processor(s) 110. Processor(s) 110 may have access to data storage areas 115 and 120. Processor(s) 110 are preferably configured to execute instructions (i.e., computer programs, such as the disclosed software) that can be stored in main memory 115 or secondary memory 120. Computer programs can also be received from baseband processor 160 and stored in main memory 110 or in secondary memory 120, or executed upon receipt. Such computer programs, when executed, can enable system 100 to perform the various functions of the disclosed embodiments.

### 2. EXAMPLE QNN MODEL

In an embodiment, the QNN is implemented based on a linear quantization scheme, such as the scheme proposed in Ref12. This quantization scheme maps each real value r to be quantized to a quantized approximation q using the following quantization operation:

$$q ( r ) = [ \frac{r}{S} + O ]$$

wherein S is a scale, O is an offset, and [⋅] represents rounding to the nearest integer. The scale S is a real-valued parameter, and the offset O is an integer parameter of quantization. This scheme is the base quantization scheme used for all approaches discussed herein. However, it should be understood that different quantization schemes may be used in alternative embodiments.

CNN quantization may comprise or consist of quantization of the weights and/or activations of the CNN. Each of these weights and activations are represented as arrays of real values. There are several ways to obtain the quantization parameters S and O. For example, in the gemmlowp library (Ref13), the scale S and offset O are computed as follows:

$$\begin{matrix}S = \frac{max ( 0 , {r}_{max} ) - min ( 0 , {r}_{min} )}{b - 1} \\ O = - \frac{min ( 0 , {r}_{min} )}{S}\end{matrix}$$

wherein rₘₐₓ is the maximum value in the respective array, rₘᵢₙ is the minimum value in the respective array, and b is a number of quantization levels (2ⁿ for n-bit quantization). In this approach, any real value of 0 is exactly represented by O, which is necessary for efficient computations and zero-padding.

However, this approach is not suitable for low-bit quantization. In low-bit quantization, only a few quantized values would represent the major part of array values, depending on distribution. To overcome this issue, the quantization parameters S and O may be obtained by solving a minimum mean-square error (MMSE) problem:

S,O:argmin( [symbol] (r−q_{S,O}(r))²)

wherein [symbol] (r−q_{S,O}(r))² is the mean-square error (MSE) function. This problem may be solved analytically for CNN activations if there is information about the distribution of r (Ref3), and/or directly for CNN weights if the array is relatively small (Ref7).

In an embodiment, for a pre-trained CNN and its training dataset, the quantization scheme for a convolutional layer is as follows:
For weights: The MMSE problem above is solved directly, as in Ref7. The MSE function has one local minimum, because the weight distribution in the CNN is approximately normal (see Ref3, Ref7). Therefore, a ternary search, or other divide-and-conquer algorithm, can be used to solve the MMSE problem.
For activations: While the MMSE problem above could be solved for activations on the entire training dataset, the computational cost would be too high. Ref7 utilizes a subset of the training dataset, but the array size is still too large. Thus, to overcome this issue, the activation distribution may be approximated by a histogram, and the MMSE problem may be solved by a ternary search or other divide-and-conquer algorithm.

In each ternary search, each value of offset O from an integer value of 0 to b−1 is considered, and the following bounds δₘᵢₙ and δₘₐₓ are assumed for the search:

$$\begin{matrix}{δ}_{min} = \frac{max ( 0 , μ + σ ) - min ( 0 , μ - σ )}{b - 1} \cdot 0.9 \\ {δ}_{max} = \frac{max ( 0 , {r}_{max} ) - min ( 0 , {r}_{min} )}{b - 1} \cdot 1.1\end{matrix}$$

wherein μ is the mean of the values in the respective array, and σ is the standard deviation of the values in the respective array. The ternary search provides the optimal scale S and MSE for a given offset O. Then, the scale S and offset O with the minimum MSE are selected as the final scale S and offset O to be used.

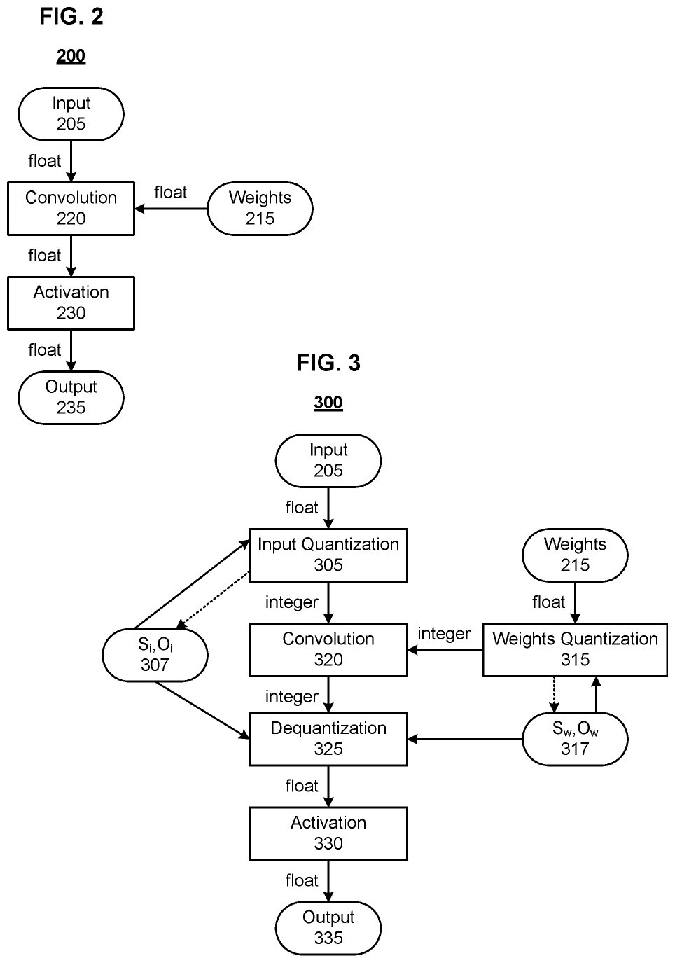

FIG. 2 illustrates a standard convolutional layer 200 in a full-precision CNN, according to an example. In convolutional layer 200, a convolution 220 with weights 215 is applied to an input 205. An activation function 230 is then applied to the output of convolution 220 to produce an activation or output 235, which may become the input 205 to a subsequent layer. Input 205, weights 215, the output of convolution 220, and output 235 may each comprise an array of one or a plurality of floating-point values (e.g., 32-bit floating-point values).

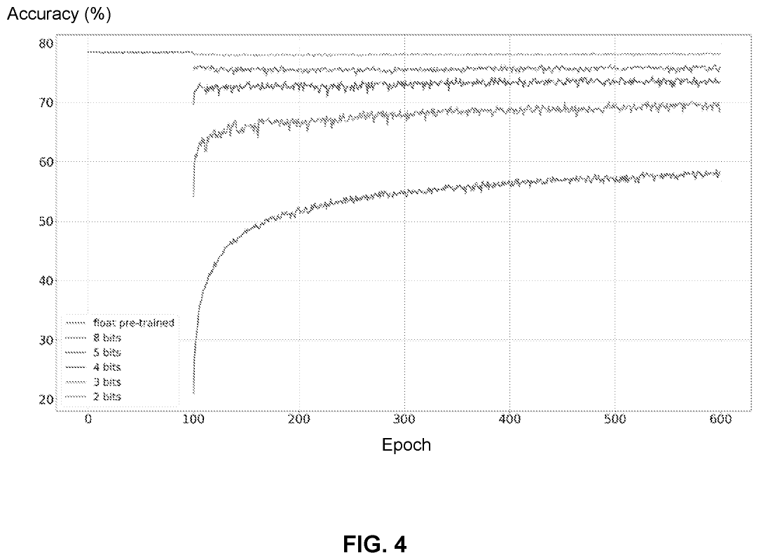

FIG. 3 illustrates a quantization module 300 that is used in place of each convolutional layer 200 to be quantized during training of a QNN, according to an embodiment. Instead of applying convolution directly to input 205, input 205 is first quantized by an input quantization module 305, which converts the floating-point values into integer values (e.g., using the quantization scheme described above). The MMSE problem may be solved by input quantization module 305, to optimize parameters 307, including a scale Sᵢ and offset Oᵢ, over inputs 205. For example, input quantization module 305 may construct a histogram of the distribution of inputs 205 over the course of training, and solve the MMSE problem to obtain the optimum values of scale Sᵢ and offset Oᵢ based on the constructed histogram. Input quantization module 305 may then use the obtained optimum values of scale Sᵢ and offset Oᵢ to calculate the quantized values of input 205 (e.g., using the quantization scheme described above).

In addition, weights 215 are quantized by a weights quantization module 315 from an array of floating-point values into an array of integer values. The MMSE problem may be solved by weights quantization module 315, as described above (e.g., using a ternary search), to optimize parameters 317, including a scale S_{w} and offset O_{w}, over inputs 205. Weights quantization module 315 may then use the obtained optimum values of scale S_{w} and offset O_{w} to calculate the quantized values of weights 215 as described above.

Convolution 320 is applied to the output of input quantization module 305, comprising the quantized value of input 205, using the output of weights quantization module 315, comprising the quantized value of weights 215, as the weights in convolution 320. The output of convolution 320 is then dequantized by a dequantization module 325 from an array of integer values to an array of floating-point values. Dequantization module 325 uses the parameters 307 and 317 for input 205 and weights 215, respectively, to reverse the quantization operation, described above, in order to convert integer values to floating-point values.

An activation function 330, which may be the same as activation function 230, is applied to the output of dequantization module 325 to produce an output 335, which may comprise floating-point values. Dequantization module 325 may be unnecessary during operation (i.e., inference) of the QNN, if activation function 330 is piecewise linear (Ref12). In other words, during operation of the trained QNN, convolution 320 may be connected directly to activation function 330 without dequantization module 325 therebetween (Ref24, Ref12). However, during training, the incorporation of dequantization module 325 provides better compatibility, for example, with the Pytorch™ pipeline.

Notably, the behavior of input quantization module 305, weights quantization module 315, and dequantization module 325 will change during different stages of training. Initially, these modules may simply pass the floating-point values as they are. However, once a sufficient number of inputs 205 has been processed, input quantization module 305 will construct the histogram of the data distribution of inputs 205 and obtain the optimum parameters 307. These optimum parameters 307 are saved for future quantization operations on inputs 205. Subsequently, weights quantization module 315 solves the MMSE problem to obtain the optimum parameters 317, and saves these optimum parameters 317 for future quantization operations on weights 215. It should be understood that, during operation of the QNN, weights quantization module 315 is unnecessary, since the final quantized integer values of weights 215 may simply be saved and retrieved during operation.

### 3. PROCESS OVERVIEW

Embodiments of processes for new QAT approaches will now be described in detail. It should be understood that the described processes may be embodied in one or more software modules that are executed by one or more hardware processors (e.g., processor 110), for example, as a computer program or software package. The described processes may be implemented as instructions represented in source code, object code, and/or machine code. These instructions may be executed directly by hardware processor(s) 110, or alternatively, may be executed by a virtual machine operating between the object code and hardware processor(s) 110.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Table 1 below describes three different architectures of neural networks that were quantized during experiments to evaluate the performance of described embodiments. In each architecture, the layers were fully connected with ten hidden units, and a Softmax function was used for the final output. In Table 1, convn-m denotes convolution 220 with m filters and a kernel size of n×n. It should be understood that, while other architectures may achieve better results, the present disclosure is related to quantization, rather than any particular architecture.

TABLE 1

| Architecture A | | Architecture B | | Architecture C | |
|---|---|---|---|---|---|
| 4 layers with weights | | 5 layers with weights | | 6 layers with weights | |
| 31,000 parameters | | 70,000 parameters | | 235,000 parameters | |
| conv5-12 | stride = 2 | conv5-12 | stride = 2 | conv5-20 | stride = 2 |
| conv3-36 | stride = 2 | conv3-36 | stride = 2 | conv3-40 | stride = 1 |
| conv3-72 | stride = 2 | conv3-60 | stride = 1 | conv3-60 | stride = 1 |
| | | conv3-80 | stride = 1 | conv3-100 | stride = 2 |
| | | | | conv3-160 | stride = 1 |

The three architectures were used to construct three baseline models. For each of the three baseline models, two models were trained for each quantization approach, resulting in six models per quantization approach. For each quantization approach, the results of the six models were averaged to obtain the performance values (e.g., accuracies) discussed herein.

The training dataset for all models was derived from the Canadian Institute for Advanced Research (CIFAR)-10 dataset (Ref15), which consists of 60,000 32×32 red-green-blue (RGB) color images, in 10 classes, with 6,000 images per class. The training dataset consisted of 50,000 of the images, and the testing dataset consisted of the remaining 10,000 images. For the first 1,500 epochs, all of the models were trained with floating-point weights, using a batch size of 2,000 and a decreasing learning rate from 3e-3 to 5e-4. Then, for the next 3,000 epochs, all of the models were trained using a batch size of 1,000 and a decreasing learning rate from 3e-4 to 6e-5. During retraining in all of the quantization approaches, the batch size was 500 and the number of epochs was 500. In experiments, a 10,000-column histogram was used to approximate the data distribution of inputs 205.

### 3.1. Direct Training

The basic idea for quantization-aware training (QAT) of a neural network is to quantize all weights on all layers, and then subsequently retrain the neural network using STE approximation for back-propagation of gradients through the quantized layers. However, quantization changes the neural network dramatically, which results in a decrease in recognition accuracy, especially for low bit-widths.

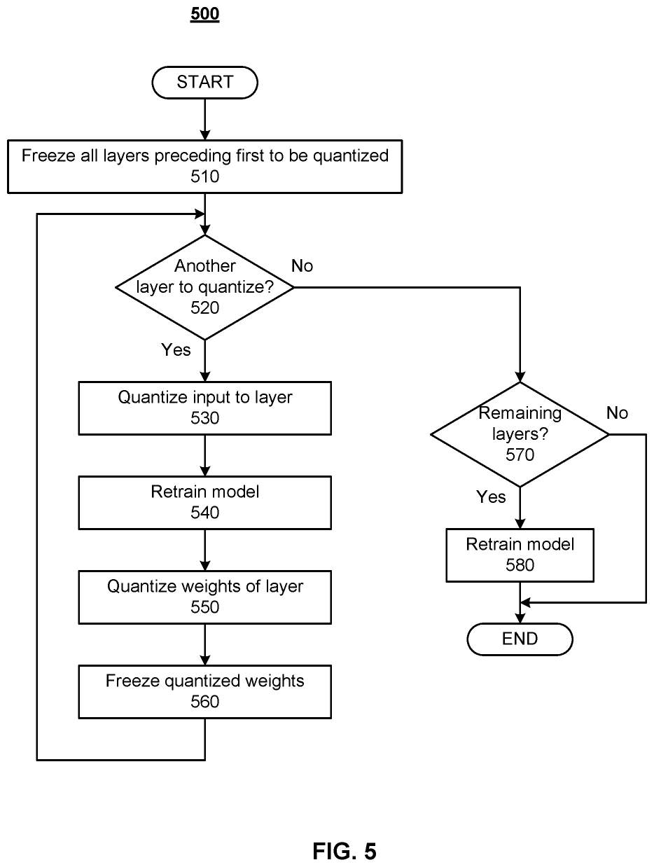

FIG. 4 illustrates the accuracy of direct training, according to an example. As illustrated, the accuracy for 2-bit quantization is less than 60%, while full-precision accuracy is nearly 80%. However, this simple approach results in sufficient accuracy (e.g., approximately 70% or above) for 5-bit to 8-bit quantization.

### 3.2. Layer-by-Layer Training

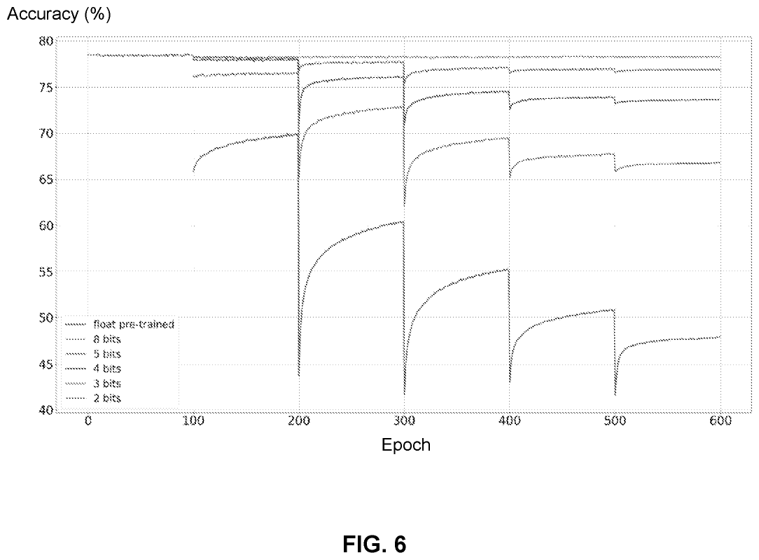

To prevent degradation or subsidence in accuracy, a layer-by-layer training approach can be used (Ref11, Ref22). FIG. 5 illustrates a process 500 for layer-by-layer training, according to an embodiment. Process 500 may be used to quantize one or more layers of a CNN that has been previously trained with floating-point weights. In process 500, the layers to be quantized are quantized and frozen. It should be understood that, when a layer is “frozen,” the weights of the layer are set at their current value, such that they are not modified any further during the training process. More generally, as used herein, to “freeze” a value or a “frozen” value means that the value will be preserved throughout the remainder of training without modification.

Initially, in subprocess 510, all layers, if any, that precede the first layer to be quantized are frozen. Then, subprocesses 520 through 560 iterate through each layer that is to be quantized. It should be understood that all layers of the CNN may be quantized, only one layer of the CNN may be quantized, or any other subset of layers of the CNN may be quantized, in this manner, depending on the particular design goals (e.g., computational objectives). In general, the layers are quantized in order from the input to the output of the CNN. If another layer remains to be quantized (i.e., “Yes” in subprocess 520), process 500 proceeds to subprocess 530. Otherwise, if no more layers remain to be quantized (i.e., “No” in subprocess 520), process 500 proceeds to subprocess 570.

In subprocess 530, input 205 of the current layer being quantized is quantized (e.g., by input quantization module 305). In subprocess 540, the model is retrained. Notably, in subprocess 540, any previously frozen weights will not be modified. In subprocess 550, weights 215 of the current layer being quantized are quantized (e.g., by weights quantization module 315). In subprocess 560, the quantized weights, output by subprocess 550, are frozen, such that they will not be modified any further during process 500.

In subprocess 570, it is determined whether or not any layers remain to be trained. It should be understood that such layers would consist of any layers that were not frozen in subprocess 510 and are not to be quantized. If any such layers exist in the neural network (i.e., “Yes” in subprocess 570), the model is retrained in subprocess 580, and then process 500 ends. Notably, in subprocess 580, any frozen weights will not be modified. If no remaining layers exist in the neural network (i.e., “No” in subprocess 570), process 500 ends.

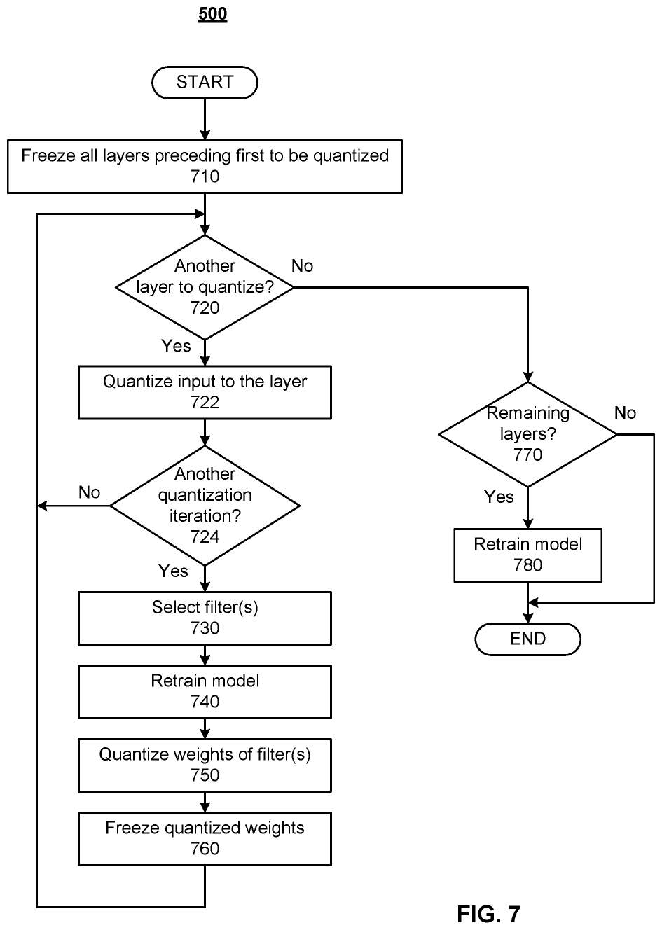

FIG. 6 illustrates the accuracy of layer-by-layer training process 500, according to an example. As illustrated, process 500 smooths the subsidence in accuracy, relative to direct training. In addition, process 500 is mathematically correct, because it does not utilize STE. However, there are noticeable drops in the accuracy of the model after the quantization of each layer (i.e., each iteration of subprocesses 520 through 560). Relative to direct training, layer-by-layer training process 500 produces a QNN with slightly higher recognition accuracy for 4-bit to 8-bit quantization, but lower recognition accuracy for 2-bit to 3-bit quantization.

### 3.3. Filter-by-Filter Training

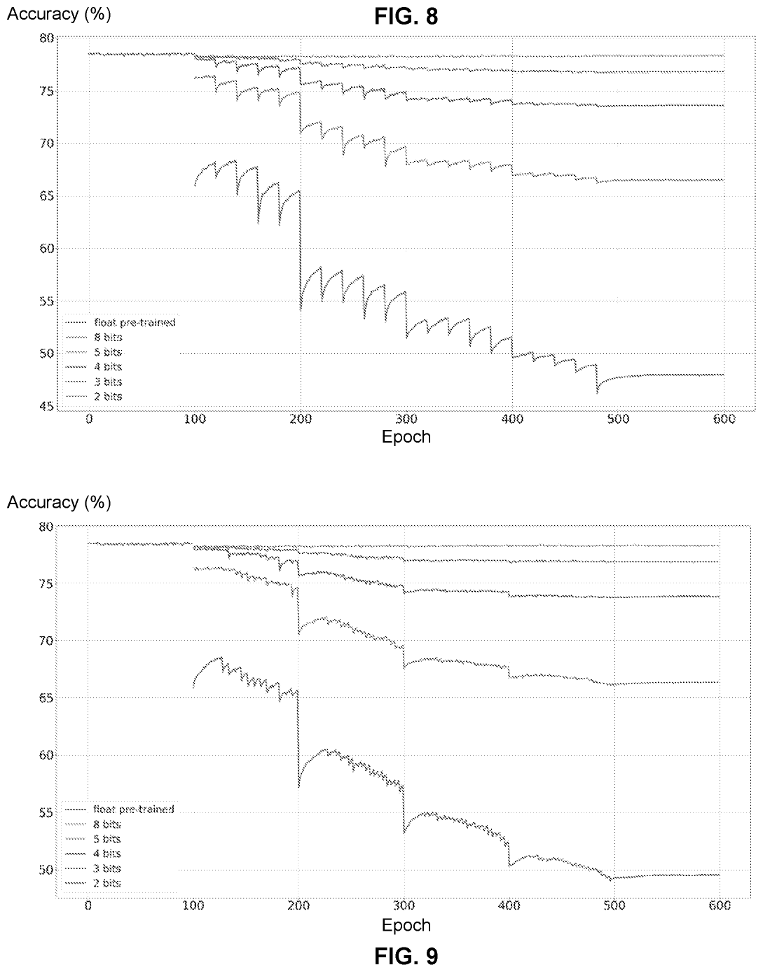

FIG. 7 illustrates a process 700 for filter-by-filter training, according to an embodiment. Process 700 may be used to quantize one or more layers of a CNN that has been previously trained with floating-point weights. In contrast to layer-by-layer training process 500, in filter-by-filter training process 700, not all of the weights in a layer are quantized at once. Rather, a subset of 1/N filters in each layer may be quantized over N quantization iterations. For example, if N=4, one quarter of the filters in the layer will be quantized and frozen in each of four quantization iterations. It should be understood that four is simply an example, and N may be any positive value.

Initially, in subprocess 710, all layers, if any, that precede the first layer to be quantized are frozen. Then, subprocesses 720 through 760 iterate through each layer that is to be quantized. If another layer remains to be quantized (i.e., “Yes” in subprocess 720), process 700 proceeds to subprocess 722. In general, the layers are quantized in order from the input to the output of the CNN. Otherwise, if no more layers remain to be quantized (i.e., “No” in subprocess 720), process 700 proceeds to subprocess 770.

In subprocess 722, the input (e.g., a subset of input 205) to the next layer to be quantized is quantized (e.g., by input quantization module 305). Then, subprocesses 724 through 760 iterate through N quantization iterations for the current layer being quantized. If another quantization iteration remains (i.e., “Yes” in subprocess 724), process 700 proceeds to subprocess 730. Otherwise, if no more quantization iterations remain (i.e., “No” in subprocess 724), process 700 returns to subprocess 720. It should be understood that another quantization iteration will remain until N iterations of subprocesses 724 through 760 have been performed. At the end of N quantization iterations, all of the filters in the layer will have been quantized and frozen.

In subprocess 730, a subset of unquantized filters, within the current layer being quantized, is selected. For example, if N=4, one-fourth of all of the filters in the layer will be selected in each quantization iteration. More generally, 1/N of all of the filters in the layer will be selected in each of the N quantization iterations. It should be understood that the subset that is selected in each iteration of subprocess 730 will be selected from those filters which have not yet been quantized, in a number equal to 1/N of all of the filters in the layer. Thus, all filters in the layer will be selected over all of the N quantization iterations for the layer.

The subset of filters may be selected according to any suitable scheme. Examples of filter-selection schemes include sequential selection (Seq), random selection (Rand), max-variance selection (Var), min-variance selection (nVar), max-MSE selection, and min-MSE selection (nMSE). In Seq, the filters are chosen sequentially in the order in which they are presented in the neural network. In Rand, the filters are chosen randomly. In Var, the filters with the maximum standard deviation, relative to their entire respective layers, are chosen in descending order. In n Var, the filters with the minimum standard deviation, relative to their entire respective layers, are chosen in descending order. In MSE, the filters with the maximum MSE between quantized and floating-point values are chosen in ascending order. In nMSE, the filters with the minimum MSE between quantized and floating-point values are chosen in ascending order. It should be understood that, in each scheme, the same number of filters is chosen in each quantization iteration.

Table 2 below depicts the accuracies (as percentages) of models with the three different architectures in Table 1, after being quantized by process 700 using each of the described filter-selection schemes in subprocess 730. Notably, these various filter-selection schemes do not produce any significant differences in the performance of the resulting QNN.

TABLE 2

| Arch. | FP-Trained | Bits | Seq | Rand | Var | nVar | MSE | nMSE |
|---|---|---|---|---|---|---|---|---|
| A | 71.60 | 8 | 71.36 | 71.39 | 71.21 | 71.33 | 71.23 | 71.40 |
| | | 5 | 69.55 | 69.37 | 69.36 | 69.52 | 69.02 | 68.90 |
| | | 4 | 65.66 | 66.31 | 65.11 | 66.24 | 65.88 | 66.03 |
| | | 3 | 58.84 | 59.33 | 59.67 | 59.65 | 58.83 | 58.54 |
| | | 2 | 44.26 | 44.23 | 43.24 | 42.80 | 44.29 | 42.29 |
| B | 78.59 | 8 | 78.60 | 78.56 | 78.69 | 78.42 | 78.49 | 78.64 |
| | | 5 | 77.08 | 77.40 | 77.08 | 77.54 | 76.77 | 77.27 |
| | | 4 | 73.98 | 74.34 | 73.27 | 73.68 | 74.03 | 73.77 |
| | | 3 | 67.02 | 67.70 | 65.61 | 67.55 | 66.64 | 66.92 |
| | | 2 | 49.72 | 49.97 | 49.57 | 51.04 | 49.14 | 49.92 |
| C | 81.62 | 8 | 81.73 | 81.37 | 81.54 | 81.49 | 81.53 | 81.54 |
| | | 5 | 79.88 | 79.82 | 80.33 | 79.53 | 80.17 | 80.13 |
| | | 4 | 77.29 | 77.23 | 77.38 | 77.64 | 77.64 | 77.64 |
| | | 3 | 70.62 | 70.63 | 70.37 | 70.69 | 71.16 | 70.48 |
| | | 2 | 48.38 | 50.65 | 49.78 | 51.26 | 50.34 | 51.00 |

In subprocess 740, the model is retrained. Notably, in subprocess 740, any previously frozen weights will not be modified. In subprocess 750, the weights (e.g., a subset of weights 215) of the current filters being quantized are quantized (e.g., by weights quantization module 315). In subprocess 760, the quantized weights, output by subprocess 750 for the selected filters, are frozen, such that they will not be modified any further during process 700.

In subprocess 770, it is determined whether or not any layers remain to be trained. It should be understood that such layers would consist of any layers that were not frozen in subprocess 710 and are not to be quantized. If any such layers exist in the neural network (i.e., “Yes” in subprocess 770), the model is retrained in subprocess 780, and then process 700 ends. Notably, in subprocess 780, any previously frozen weights will not be modified. If no remaining layers exist in the neural network (i.e., “No” in subprocess 770), process 700 ends.

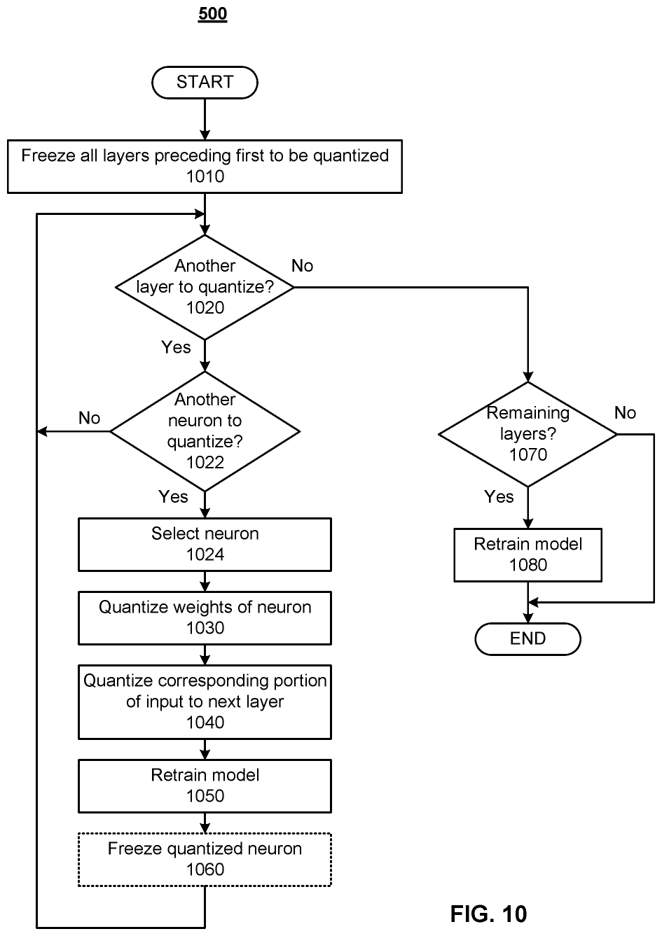

FIG. 8 illustrates the accuracy of the filter-by-filter training of process 700, according to an example in which N=4. As illustrated, the training is smoother for the quantization of weights 215 inside one layer. However, there are still significant drops in accuracy in the quantization input stages (e.g., epochs 100, 200, 300, and 400).

Filter-by-filter training process 700 may be improved by increasing N, which has the effect of decreasing the size of the subsets of filters that are trained in each quantization iteration. FIG. 9 illustrates the accuracy of filter-by-filter training process 700, when smaller subsets of filters are trained in a greater number of quantization iterations, according to an embodiment. Since the amount of filters that are frozen in each quantization iteration for a layer is small, the training process is smoother, and the resulting accuracy is slightly higher. However, the significant drops in accuracy in the quantization input stages remain significant.

### 3.4. Neuron-by-Neuron Training

In filter-by-filter training process 700, weights 215 were quantized gradually, but inputs 205 were quantized in the same manner as in layer-by-layer training process 500. As discussed above, this resulted in a significant drop in accuracy whenever input 205 was quantized.

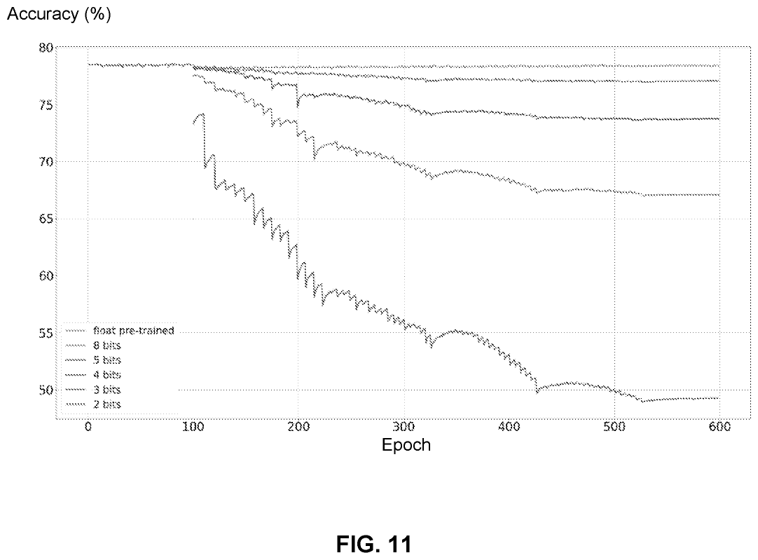

FIG. 10 illustrates a process 1000 for neuron-by-neuron training, according to an embodiment. Process 1000 may be used to quantize one or more layers of a CNN that has been previously trained with floating-point weights. In contrast to layer-by-layer training process 500 and filter-by-filter training process 700, in neuron-by-neuron training process 1000, one neuron is frozen at a time. A neuron is the combination of a linear operation of one or more filters in a convolution 320 with the corresponding subsequent non-linear activation of their output by activation 330. In neuron-by-neuron training process 1000, an entire neuron, comprising both a subset of filters in a convolution 320 and the corresponding output from activation 330 as an input 205 to the next layer, are frozen in each of a plurality of iterations.

Initially, in subprocess 1010, all layers, if any, that precede the first layer to be quantized are frozen. Then, subprocesses 1020 through 1060 iterate through each layer that is to be quantized. If another layer remains to be quantized (i.e., “Yes” in subprocess 1020), process 1000 proceeds to subprocess 1022. In general, the layers are quantized in order from the input to the output of the CNN. Otherwise, if no more layers remain to be quantized (i.e., “No” in subprocess 1020), process 1000 proceeds to subprocess 1070.

Subprocesses 1022 through 1060 iterate through each neuron in the current layer being quantized. If another neuron remains (i.e., “Yes” in subprocess 1022), process 1000 proceeds to subprocess 1024. Otherwise, if no more neurons remain (i.e., “No” in subprocess 1022), process 1000 returns to subprocess 1020. In this case, all of the neurons in the current layer will have been quantized and frozen.

In subprocess 1024, a neuron is selected from the current layer being quantized. The neuron may be selected according to any suitable scheme, including Seq, Rand, Var, nVar, MSE, or nMSE. It should be understood that a neuron comprises both a subset of filters, representing a linear operation, and a non-linear activation by activation function 330 of the output of that subset of filters.

In subprocess 1030, weights 215 of the current neuron being quantized are quantized (e.g., by weights quantization module 315). In subprocess 1040, output 335 from the neuron, representing a corresponding portion of input 205 to the subsequent layer, is quantized (e.g., by input quantization module 305 of the next layer). In subprocess 1050, the model is retrained. Notably, in subprocess 1050, any previously frozen weights will not be modified. In subprocess 1060, the weights of the quantized neuron are frozen, such that they will not be modified any further during process 1000. In an alternative embodiment (e.g., with gradient forwarding to all or just the last quantized layers), subprocess 1060 may be omitted, such that the weights of the quantized neuron are not frozen.

In subprocess 1070, it is determined whether or not any layers remain to be trained. It should be understood that such layers would consist of any layers that were not frozen in subprocess 1010 and are not to be quantized. If any such layers exist in the neural network (i.e., “Yes” in subprocess 1070), the model is retrained in subprocess 1080, and then process 1000 ends. Notably, in subprocess 1080, any previously frozen weights will not be modified. If no remaining layers exist in the neural network (i.e., “No” in subprocess 1070), process 1000 ends.

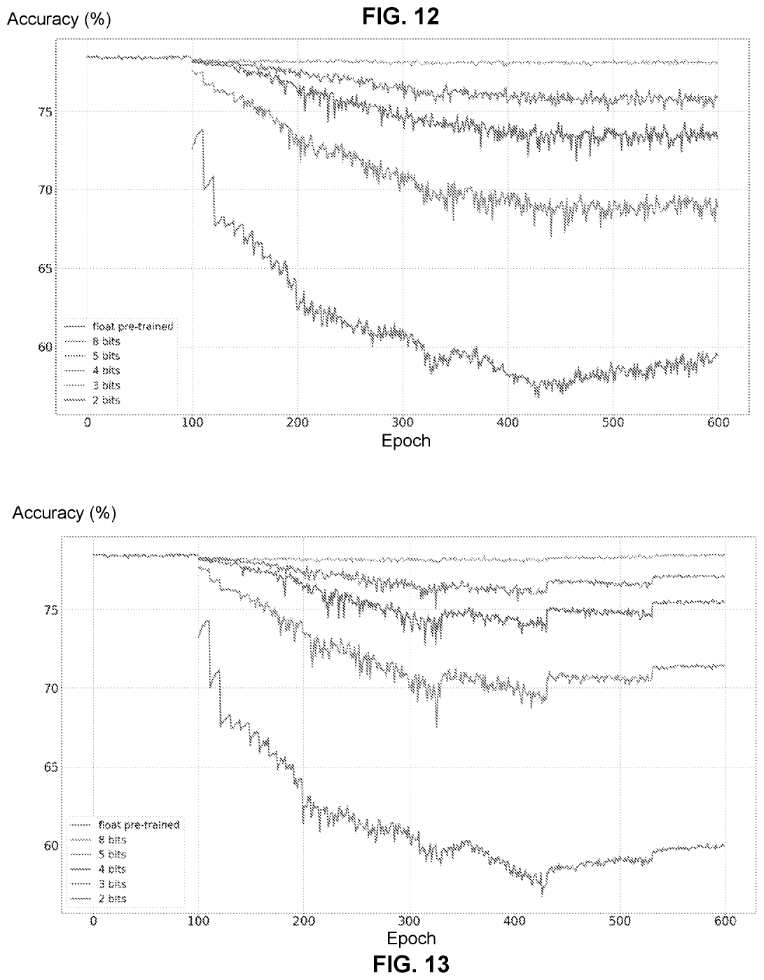

FIG. 11 illustrates the accuracy of neuron-by-neuron training process 1000, according to an example. As illustrated, neuron-by-neuron training process 1000 produces slightly better accuracy than filter-by-filter training process 700, and is still comparable in accuracy to layer-by-layer training process 500. In addition, neuron-by-neuron training process 1000 reduces or eliminates the subsidence of accuracy following input quantization that was present in filter-by-filter training process 700.

Neuron-by-neuron training process 1000 may be improved by gradient forwarding. In a first embodiment, gradients are forwarded to all the quantized layers using STE within the context of back-propagation, in a similar manner as in direct training, except that the neurons, comprising quantized weights and activations, are trained consecutively and smoothly, neuron by neuron. FIG. 12 illustrates the accuracy of neuron-by-neuron training process 1000 with gradient forwarding to all quantized layers of the neural network, according to this first embodiment. As illustrated, this results in a very “noisy” training process, since a small change at the beginning of the neural network seriously affects the rest of the neural network. Nevertheless, the accuracy for 2-bit and 3-bit quantization increases dramatically, from under 50% to nearly 60% for 2-bit quantization and from approximately 67% to almost 72% for 3-bit quantization.

In a second embodiment, the gradient is propagated through the quantized layer using STE to only the layer that immediately precedes the current layer under quantization in the forward order (i.e., from the input to the output of the neural network). FIG. 13 illustrates the accuracy of neuron-by-neuron training of process 1000 with gradient forwarding from only the previous layer, according to this second embodiment. As a layer-by-layer approach, this second embodiment is greedy and has low noise. However, this second embodiment enables the neural network to adapt weights 215 of a layer based on the quantization of the subsequent layer. In addition, this second embodiment produces better accuracy than the first embodiment of neuron-by-neuron training with gradient forwarding, as well as neuron-by-neuron training without gradient forwarding.

To illustrate gradient forwarding, assume a neural network comprises layers L1, L2, L3, and L4 in forward order, and that L3 is currently under quantization (e.g., in an iteration of subprocesses 1020 through 1050 or 1020 through 1060). Without gradient forwarding (FIG. 11), only L4 and the remaining portion of L3 would be retrained in subprocess 1050. With full gradient forwarding (FIG. 12), all layers L1, L2, L3, and L4 would be retrained in subprocess 1050, and the gradient from L3 would be forwarded to L2 and the gradient from L2 would be forwarded to L1 using STE. With gradient forwarding to only the preceding layer (FIG. 13), layers L2, L3, and L4 would be retrained in subprocess 1050, but the weights in L1 would be frozen.

### 3.5. Deployment

A QNN may be trained using an embodiment of any of the disclosed component-by-component training processes discussed above. The components may be filters, such as in filter-by-filter training process 700, or neurons, such as neuron-by-neuron training process 1000. In either case, the trained QNN may be deployed to a device for operation. Although the device may be any device (e.g., smartphones, tablet computers, personal computers, servers, etc.), QNNs are generally most beneficial for resource-constrained devices. Examples of resource-constrained devices, to which the QNN may be deployed, are SoC devices, IoT devices, or other devices that utilize ASICs, FPGAs, and/or low-power CPUs that are not sufficiently efficient to operate large CNNs.

Once deployed to the device, the QNN may be operated on the device to perform inference. In particular, the QNN may be applied to an input to predict, forecast, classify, or otherwise infer an output. It should be understood that the QNN may be used in any context and for any application in which a CNN would be appropriate. Examples of such applications include, without limitation, image or object recognition or classification (e.g., for computer vision), facial recognition, document analysis, video analysis, natural language processing, anomaly detection, time series forecasting, drug forecasting, gaming, and the like.

### 4. EXPERIMENTAL RESULTS

Table 3 below depicts the accuracy (as a percentage) on the same testing dataset, averaged over six models, for each architecture in Table 1 and each of the disclosed quantization approaches using each of five bit-widths. “LbL” denotes layer-by-layer training process 500, “FbF” denotes filter-by-filter training process 700 with four quantization iterations per layer (i.e., N=4), “FbF-s” denotes filter-by-filter training process 700 with smooth quantization (i.e., many quantization iterations per layer), “NbN” denotes neuron-by-neuron training process 1000 without gradient forwarding, “NbN ste” denotes neuron-by-neuron training process 1000 in which the quantized layers are trained with gradient forwarding using STE gradient approximation, and “NbN ste-11” denotes neuron-by-neuron training process 1000 in which the quantized layers are trained with gradient forwarding that only applies STE gradient approximation in back-propagation to the layer that is previous to the layer being quantized.

TABLE 3

| | FP | | | | FbF | FbF | FbF | FbF-s | FbF-s | FbF-s | | NbN | NbN |
|---|---|---|---|---|---|---|---|---|---|---|---|---|---|
| Arch. | Train | Bits | Direct | LbL | rand | var | nvar | rand | var | nvar | NbN | ste | ste-11 |
| A | 72.3 | 8 | 71.3 | 71.7 | 71.7 | 71.7 | 71.6 | 71.7 | 71.7 | 71.6 | 71.7 | 71.2 | 71.8 |
| | | 5 | 68.9 | 69.7 | 69.7 | 69.8 | 69.7 | 69.7 | 69.7 | 69.5 | 69.6 | 69.2 | 70.4 |
| | | 4 | 66.5 | 66.2 | 66.0 | 65.5 | 66.3 | 66.0 | 65.6 | 66.2 | 66.5 | 65.2 | 68.2 |
| | | 3 | 62.0 | 58.4 | 58.8 | 58.9 | 59.1 | 59.1 | 58.8 | 59.0 | 59.3 | 61.0 | 63.9 |
| | | 2 | 46.8 | 43.2 | 41.8 | 42.6 | 41.6 | 42.3 | 42.4 | 41.6 | 43.0 | 51.9 | 52.4 |
| B | 78.7 | 8 | 78.2 | 78.3 | 78.3 | 78.4 | 78.3 | 78.3 | 78.4 | 78.4 | 78.4 | 78.0 | 78.4 |
| | | 5 | 75.9 | 76.9 | 76.8 | 76.6 | 76.9 | 76.9 | 76.8 | 77.1 | 77.0 | 75.8 | 77.1 |
| | | 4 | 73.5 | 73.6 | 73.6 | 73.7 | 73.2 | 73.8 | 73.7 | 73.2 | 73.7 | 73.9 | 75.6 |
| | | 3 | 68.5 | 66.8 | 66.5 | 66.3 | 67.2 | 66.4 | 66.5 | 67.0 | 67.1 | 69.3 | 71.3 |
| | | 2 | 58.2 | 47.9 | 48.0 | 48.6 | 48.0 | 49.5 | 48.8 | 48.8 | 49.3 | 59.5 | 60.1 |
| C | 81.2 | 8 | 80.2 | 80.4 | 80.4 | 80.5 | 80.1 | 80.5 | 80.5 | 80.5 | 80.4 | 80.0 | 80.5 |
| | | 5 | 77.9 | 78.6 | 78.6 | 78.8 | 78.2 | 78.6 | 78.7 | 78.7 | 79.0 | 77.7 | 78.8 |
| | | 4 | 75.4 | 75.5 | 75.4 | 75.3 | 74.9 | 75.5 | 75.3 | 75.6 | 75.7 | 74.9 | 77.2 |
| | | 3 | 71.4 | 67.2 | 67.1 | 66.6 | 67.5 | 66.9 | 66.5 | 68.0 | 68.3 | 70.6 | 73.2 |
| | | 2 | 57.4 | 46.9 | 47.2 | 46.4 | 47.5 | 47.7 | 47.5 | 47.7 | 48.2 | 59.4 | 60.8 |

As demonstrated in Table 3, the QNN that was trained using neuron-by-neuron training process 1000 with the STE gradient approximation applied only to the previous layer (i.e., NbN ste-11) had the highest accuracy among all architectures and bit-widths. Filter-by-filter training process 700 produced a QNN with similar quality as the QNN produced by layer-by-layer training process 500. Presumably, this is caused by the dramatic changes in the neural network after quantization of the whole input 205 of a convolutional layer.

Notably, the back-propagation of the gradient using STE significantly improved neuron-by-neuron training process 1000. Without STE, neuron-by-neuron training process 100 produces lower accuracy than direct training on 2-bit and 3-bit QNNs. Restricting the number of layers to which the gradient is propagated further improves the neuron-by-neuron training. This is likely connected to the decrease of “noise” during training.

Notably, during training, some of the training processes do not reach the limit of their potential accuracy before the next quantization happens. This is caused by a restriction on the number of training epochs, which was applied to all of the training processes during testing.

In summary, the present disclosure describes several new QAT approaches for quantizing CNNs. Each approach was based on a layer-by-layer approach, but was designed to improve significant drawbacks in the layer-by-layer approach. These drawbacks include the subsidence of the accuracy of the resulting QNN, caused by simultaneous quantization of the whole layer, and the absence of retraining of the quantized layers. In an embodiment, the subsidence in accuracy is resolved by gradually quantizing a plurality of components of each convolutional layer to be quantized. These components may be filters (i.e., a subset of weights) or neurons (i.e., a subset of weights and corresponding activations) within the layer. In an embodiment of neuron-by-neuron training, the absence of retraining of the quantized layers is resolved by back-propagating the gradient using STE, in the same or similar manner as an indirect approach. However, a restriction on the number of layers to which the gradient is propagated increases the quality of the resulting QNN.

Experiments, using a CNN trained for image recognition on the CIFAR-10 dataset, demonstrated that the disclosed approaches are superior to direct and layer-by-layer approaches in terms of recognition accuracy. The disclosed approaches are suitable for quantizations with arbitrary bit-width, and eliminate significant drops in accuracy during training, which results in the QNN having better accuracy. During experimentation, neuron-by-neuron training produced a QNN with an accuracy of 73.2% for 3-bit quantization, whereas direct training produced an accuracy of 71.4% and layer-by-layer training produced an accuracy of 67.2 from the same CNN.

### 5. References

The present disclosure may refer to the following references, which are all hereby incorporated herein by reference as if set forth in their entireties:
Ref1: Agafonova et al., “Efficiency of machine learning algorithms and convolutional neural network for detection of pathological changes in MR images of the brain,” Computer Optics 44(2), 266-273 (2020);
Ref2: Alemdar et al., “Ternary neural networks for resource-efficient AI applications,” in 2017 International Joint Conference on Neural Networks (IJCNN). pp. 2547-2554, IEEE (2017);
Ref3: Banner et al., “Post training 4-bit quantization of convolutional networks for rapid-deployment, “Advances in Neural Information Processing Systems 32 (2019);
Ref4: Bengio et al., “Estimating or propagating gradients through stochastic neurons for conditional computation,” arXiv: 1308.3432 (2013);
Ref5: Chernyshova et al., “Localization of characters horizontal bounds in text line images with fully convolutional network,” Wolf-gang Osten, Dmitry Nikolaev, J. Z. (ed.) ICMV 2019, vol. 11433, pp. 1-8, Society of Photo-Optical Instrumentation Engineers (SPIE), Bellingham, Washington 98227-0010 USA (January 2020), doi: 10.1117/12.2559449;
Ref6: Chollet et al., Keras, keras.io (2015);
Ref7: Choukroun et al., “Low-bit quantization of neural networks for efficient inference,” 2019 IEEE/CVF International Conference on Computer Vision Workshop (ICCVW), pp. 3009-3018, IEEE (2019);
Ref8: Gholami et al., “A survey of quantization methods for efficient neural network inference,” arXiv:2103.13630 (2021);
Ref9: Guo, “A survey on methods and theories of quantized neural networks,” arXiv:1808.04752 (2018);
Ref10: Hubara et al., “Quantized neural networks: Training neural networks with low precision weights and activations,” The Journal of Machine Learning Research 18(1), 6869-6898 (2017);
Ref11: Ilin et al., “Fast integer approximations in convolutional neural networks using layer-by-layer training,” Antanas Verikas, Petia Radeva, D.P.N.W.Z.J.Z. (ed.) ICMV 2016, vol. 10341, pp. 1-5, Society of Photo-Optical Instrumentation Engineers (SPIE), Bellingham, Washington 98227-0010 USA (July 2017), doi: 10.1117/12.2268722;
Ref12: Jacob et al., “Quantization and training of neural networks for efficient integer-arithmetic-only inference,” Proceedings of the IEEE Conference on Computer Vision and Pattern Recognition, pp. 2704-2713 (2018);
Ref13: Jacob et al., “gemmlowp: a small self-contained low-precision GEMM library,” (2017), github.com/google/gemmlowp;
Ref14: Janiszewski et al., “Achieving statistical dependence of the CNN response on the input data distortion for OCR problem, ITiVS (4), 94-101 (2019), doi: 10.14357/20718632190409;
Ref15: Krizhevsky et al., “Learning multiple layers of features from tiny images,” (2009);
Ref16: Long et al., “Fully convolutional networks for semantic segmentation,” Proceedings of the IEEE Conference on Computer Vision and Pattern Recognition, pp. 3431-3440 (2015);
Ref17: Motamedi et al., “Machine intelligence on resource-constrained IoT devices: The case of thread granularity optimization for CNN inference,” ACM Transactions on Embedded Computing Systems (TECS) 16(5s), 1-19 (2017);
Ref18: Nagel et al., “A white paper on neural network quantization,” arXiv:2106.08295 (2021);
Ref19: Paszke et al., “Pytorch: An imperative style, high-performance deep learning library,” Wallach, H., Larochelle, H., Beygelzimer, A., d'Alch'e-Buc, F., Fox, E., Garnett, R. (eds.) Advances in Neural Information Processing Systems 32, pp. 8024-8035. Curran Associates, Inc. (2019);
Ref20: Qin et al., “Binary neural networks: A survey,” Pattern Recognition 105, 107281 (2020);
Ref21: Sheshkus et al., “Combining convolutional neural networks and Hough transform for classification of images containing lines,” Antanas Verikas, Petia Radeva, D.P.N.W.Z.J.Z. (ed.) ICMV 2016, vol. 10341, pp. 1-5, Society of Photo-Optical Instrumentation Engineers (SPIE), Bellingham, Washington 98227-0010 USA (July 2017), doi: 10.1117/12.2268717;
Ref22: Shin et al., “Fixed-point optimization of deep neural networks with adaptive step size retraining,” 2017 IEEE International Conference on Acoustics, Speech and Signal Processing (ICASSP), pp. 1203-1207, IEEE (2017);
Ref23: Simonyan et al., “Very deep convolutional networks for large-scale image recognition,” arXiv: 1409.1556 (2014); and
Ref24: Trusov et al., “Fast implementation of 4-bit convolutional neural networks for mobile devices,” ICPR 2020, pp. 9897-9903, IEEE (May 2021), doi: 10.1109/ICPR48806.2021.9412841.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method of training a neural network comprising using at least one hardware processor to:
for each layer to be quantized in the neural network, for each of a plurality of iterations, until all of a plurality of components of the layer are quantized,
select a subset of the plurality of components, wherein each of the plurality of components comprises weights,
quantize the weights in the subset of components,
retrain the neural network, and
freeze the subset of components, such that the subset of components is not subsequently modified during training.

2. The method of claim 1, wherein each of the plurality of components is a neuron that comprises one or more filters and an activation that produces an input to a subsequent layer from an output of the one or more filters.

3. The method of claim 2, further comprising using the at least one hardware processor to, for each of the plurality of iterations, quantize a corresponding portion of the input to the subsequent layer.

4. The method of claim 3, wherein freezing the subset of components comprises freezing weights of the one or more filters.

5. The method of claim 3, further comprising using the at least one hardware processor to:
construct a histogram of a data distribution of inputs to the subsequent layer; and
solve a minimum mean-square error problem to obtain one or more parameters of quantization based on the constructed histogram,
wherein the one or more parameters are used to quantize the input to the subsequent layer.

6. The method of claim 5, wherein the one or more parameters comprise a scale S having a real value and an offset O having an integer value, and wherein quantizing the input comprises performing a quantization operation on each real-valued element r in an input array as follows:
$$q ( r ) = [ \frac{r}{S} + O ]$$
wherein q(r) is a quantized value for the real-valued element r.

7. The method of claim 2, wherein each subset of components consists of a single neuron.

8. The method of claim 2, wherein retraining the network comprises back-propagating gradients to all quantized layers.

9. The method of claim 2, wherein retraining the network comprises back-propagating a gradient from the layer to another layer that immediately precedes the layer in forward order of the neural network.

10. The method of claim 1, wherein each of the plurality of components is a filter.

11. The method of claim 10, wherein a number of the plurality of iterations is predefined as N, and selecting the subset of components comprises selecting 1/N filters within the layer, such that all filters in the layer are selected over the plurality of iterations.

12. The method of claim 11, wherein N≥4.

13. The method of claim 10, wherein the subset of components consists of one or more filters, and wherein freezing the subset of components comprises freezing weights of the one or more filters in the subset of components.

14. The method of claim 13, further comprising using the at least one hardware processor to, for each of the plurality of iterations, prior to retraining the neural network, quantize an input to the one or more filters in the subset of components.

15. The method of claim 14, further comprising using the at least one hardware processor to:
construct a histogram of a data distribution of inputs to the subset of components; and
solve a minimum mean-square error problem to obtain one or more parameters of quantization based on the constructed histogram,
wherein the one or more parameters are used to quantize the input.

16. The method of claim 15, wherein the one or more parameters comprise a scale S having a real value and an offset O having an integer value, and wherein quantizing the input comprises performing a quantization operation on each real-valued element r in an input array as follows:
$$q ( r ) = [ \frac{r}{S} + O ]$$
wherein q(r) is a quantized value for the real-valued element r.

17. The method of claim 1, wherein quantizing the weights comprises solving:
S,O:argmin( [symbol] (r−q_{S,O}(r))²)
wherein S is a scale having a real value, O is an offset having an integer value, and [symbol] (r−q_{S,O}(r))² is a mean-square error function that calculates an error between real values r of the weights and quantized values q_{S,O}(r), wherein
$${q}_{S , O} ( r ) = [ \frac{r}{S} + O ] .$$

18. The method of claim 17, wherein the solving comprises a ternary search.

19. A system comprising:
at least one hardware processor; and
one or more software modules that are configured to, when executed by the at least one hardware processor, train a neural network by
for each layer to be quantized in the neural network, for each of a plurality of iterations, until all of a plurality of components of the layer are quantized,
selecting a subset of the plurality of components, wherein each of the plurality of components comprises weights,
quantizing the weights in the subset of components,
retraining the neural network, and
freezing the subset of components, such that the subset of components is not subsequently modified during training.

20. A non-transitory computer-readable medium having instructions stored therein, wherein the instructions, when executed by a processor, cause the processor to train a neural network by:
for each layer to be quantized in the neural network, for each of a plurality of iterations, until all of a plurality of components of the layer are quantized,
selecting a subset of the plurality of components, wherein each of the plurality of components comprises weights,
quantizing the weights in the subset of components,
retraining the neural network, and
freezing the subset of components, such that the subset of components is not subsequently modified during training.
